(19) United States
(12) Patent Application Publication
(10) Pub. No.: US 2006/0015680 A1
(43) Pub. Date: Jan. 19, 2006

(54) Apparatus and method for data storage, and computer product

(75) Inventors: Hiroshi Otsuka, Kawasaki (JP); Yasuhiro Onda, Nagoya (JP); Fumio Yamazaki, Nagoya (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/995,184

(22) Filed: Nov. 24, 2004

(30) Foreign Application Priority Data
Jul. 16, 2004 (JP) 2004-210042

(51) Int. Cl. G06F 12/00

(52) U.S. Cl. 711/111; 711/154

(57) ABSTRACT

A data storage apparatus includes a first storing unit that stores data in a sequential-access recording medium, and that stores storage history information relating to the data stored. The sequential-access recording medium stores the data by sequential access, and a second storing unit that stores any one of specific data and data excluding the specific data, in the sequential-access recording medium. The second storing unit detects the specific data from among the data stored, based on the storage history information.

### BACKGROUND OF THE INVENTION

1) Field of the Invention

The present invention relates to an apparatus and a method for data storage, and a computer product that can increase the data storage efficiency of a magnetic tape and the like, which stores data by sequential access.

2) Description of the Related Art

Conventionally, to safeguard loss of data stored in a hard disk apparatus, the data is stored on a magnetic tape or the like as a backup. Magnetic tapes are suitable for data backup, because magnetic tapes have a larger data storage capacity than a hard disk apparatus, and are less expensive.

Conventionally, there are several standards for this kind of magnetic tape. For example, in a standard known as linear tape-open (LTO), a cartridge that covers the magnetic tape is designed to be more compact than the magnetic tape itself, the data being read and written by eight heads for more rapid access (see Certance, Hewlett-Packard and IBM, “Ultrium Format: Datasheet”, online, searched on Jun. 8, 2004, Internet URL: http://www.lto-technology.com/newsite/html/format_datasheet.html).

However, in the conventional technique, the data is written onto the magnetic tape by sequential access, in which the data is written sequentially from the head of the magnetic tape. Therefore, when data that is previously written onto the magnetic tape is no longer needed, there is a wasteful storage region where the unwanted data is written.

As the storage region where unwanted data is written gradually increases, the region where data can be newly stored decreases, and the data storage efficiency of the magnetic tape decreases. Accordingly, it is important to develop a technology for increasing the storage efficiency of a magnetic tape.

### SUMMARY OF THE INVENTION

It is an object of the present invention to at least solve the problems in the conventional technology.

A data storage apparatus according to an aspect of the present invention includes a first storing unit that stores data in a sequential-access recording medium based on sequential access and stores storage history information relating to storage history of the data stored in the sequential-access recording medium; and a second storing unit that searches data in the sequential-access recording medium using the storage history information, and stores any one of specific data, which is data obtained as a result of search of data in the sequential-access recording medium, and data excluding the specific data in the sequential-access recording medium based on sequential access.

A data storage method according to another aspect of the present invention includes a data storing including storing data in a sequential-access recording medium, and storing storage history information relating to the data stored, wherein the sequential-access recording medium stores the data by sequential access; and a data re-storing including storing any one of specific data and data excluding the specific data, in the sequential-access recording medium, wherein the specific data is detected from among the data stored, based on the storage history information.

A data storage apparatus according to still another aspect of the present invention includes a first recording medium; a second recording medium; a storing unit that stores at least storage history information relating to storage history of information stored in the first recording medium; and a controller that provides control to store only specific information from among the information stored in the first recording medium, in the second recording medium, based on the storage history information stored.

A data storage method according to still another aspect of the present invention includes detecting invalid data from among data stored in a first recording medium; and storing data excluding the invalid data detected, into a second recording medium.

A data storage apparatus according to still another aspect of the present invention includes a detector that detects specific data from among data stored in a first recording medium; and a controller that provides control to store any one of the data detected and data not detected, into a second recording medium.

A data input/output control apparatus according to still another aspect of the present invention includes a first input/output unit; a second input/output unit; a detector that detects specific data from among data input by the first input/output unit; and a controller that provides control to output any one of the specific data or data excluding the specific data, to the second input/output unit, based on the result of the detection made by the detector.

Computer-readable recording media according to still other aspects of the present invention store therein computer programs that cause a computer to realize the above methods according to the present invention.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram to explain a data backup process of a data storage apparatus according to the present invention;

FIG. 2 is a diagram to explain a concept of a data storage process;

FIG. 3 is functional configuration diagram of the data storage apparatus according to a first embodiment;

FIG. 4 is an example of storage history data;

FIG. 5 is a flowchart of a process procedure of a garbage collection process;

FIG. 6 is an example of storage history data according to a second embodiment; and

FIG. 7 is a block diagram of a hardware configuration of a computer that executes a data storage process.

### DETAILED DESCRIPTION

Exemplary embodiments of an apparatus and a method for data storage, and a computer product according to the present invention will be explained below with reference to the accompanying drawings.

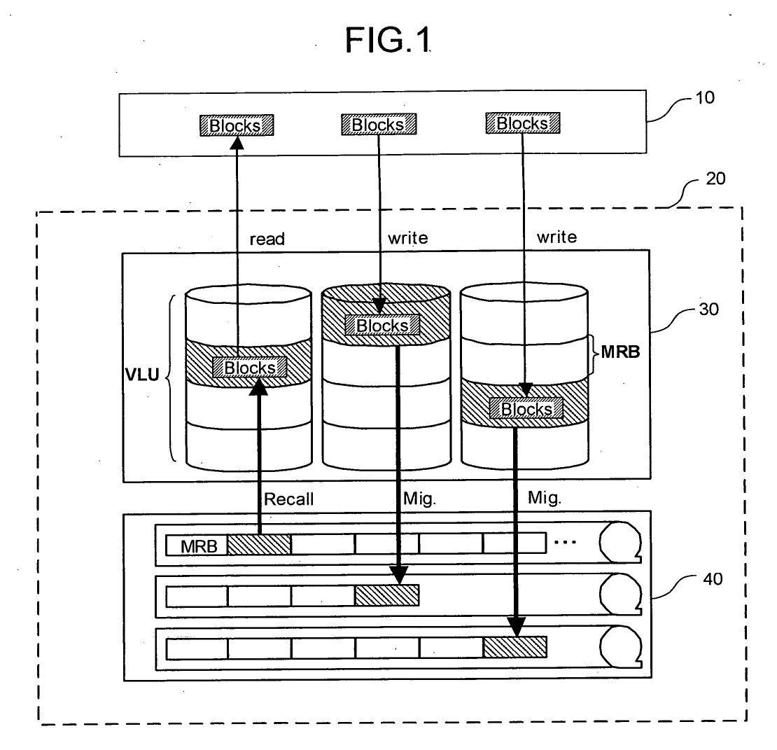

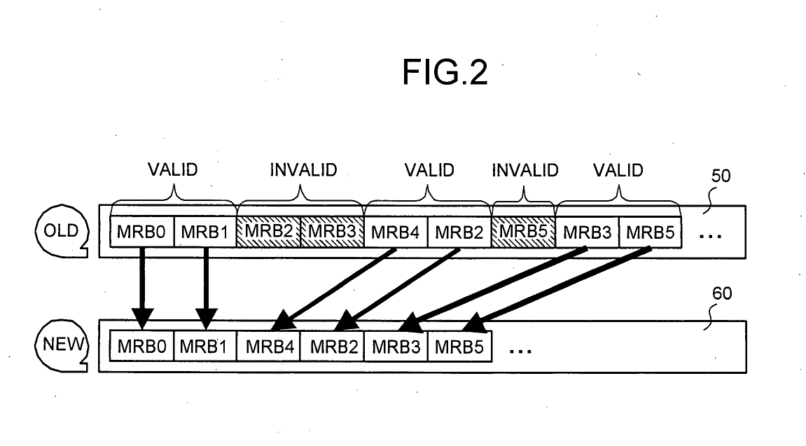

A concept of a data storage control process according to the present invention will be explained first. FIG. 1 is a diagram to explain a data backup process of a data storage apparatus 20 according to the present invention, and FIG. 2 is a diagram to explain a concept of a data storage process.

As shown in FIG. 1, a data management server apparatus 10 accesses the data storage apparatus 20, and reads/writes data in block units. The data management server apparatus 10 manages text, images, or research test data, and the like. The data storage apparatus 20 receives a data read/write request from the data management server apparatus 10, and executes data reading/writing processing accordingly.

The data storage apparatus 20 uses a hard disk apparatus as its primary storage 30, and a magnetic tape storage apparatus as its secondary storage 40. The primary storage 30 utilizes the Redundant Arrays of Independent Disks (RAID) technology to manage a plurality of hard disk apparatuses together as a single hard disk apparatus.

The volume of each hard disk apparatus is managed as a virtual logical unit (VLU). In addition, each VLU is divided into migration/recall blocks (MRB) that are units in which data is read from and written into, in the secondary storage 40. The size of one MRB is normally between several tens of megabytes and several hundred megabytes.

The primary storage 30 stores (writes) data, for which the data management server apparatus 10 sends a write request, by random access. Then, the data stored in the primary storage 30 is backed up (migrated) by sequential access onto the magnetic tape of the secondary storage 40 at a predetermined timing.

Among the data migrated to the secondary storage 40, data referenced by the data management server apparatus 10 is recalled as necessary to the primary storage 30, and is read by the data management server apparatus 10.

The data access speed of the primary storage 30 is more than that of the secondary storage 40, whereas the secondary storage 40 has a larger storage capacity than the primary storage 30. Therefore, a storage apparatus that benefits the respective advantages of the primary storage 30 and the secondary storage 40 can be configured by combining them in the manner described above.

Reading and writing of data between the primary storage 30 and the secondary storage 40 is controlled by a data storage management server (described later), and the data management server apparatus 10 reads and writes data only to/from the primary storage 30. Therefore, the data management server apparatus 10 can, in effect, use the primary storage 30 as a large-capacity storage apparatus.

As shown in FIG. 2, in a data storage process, invalid data is detected from among data stored on a magnetic tape 50, and data excluding the invalid data is stored on a new magnetic tape 60. Invalid data becomes pre-updated data after the data stored in the primary storage 30 is updated and stored in the secondary storage 40.

In this way, by deleting the invalid data and storing only the required data, storage regions that are otherwise wasted, can be deleted, and the data storage efficiency increases. This process of increasing the useful storage region by collecting and deleting invalid data is termed “garbage collection”S.

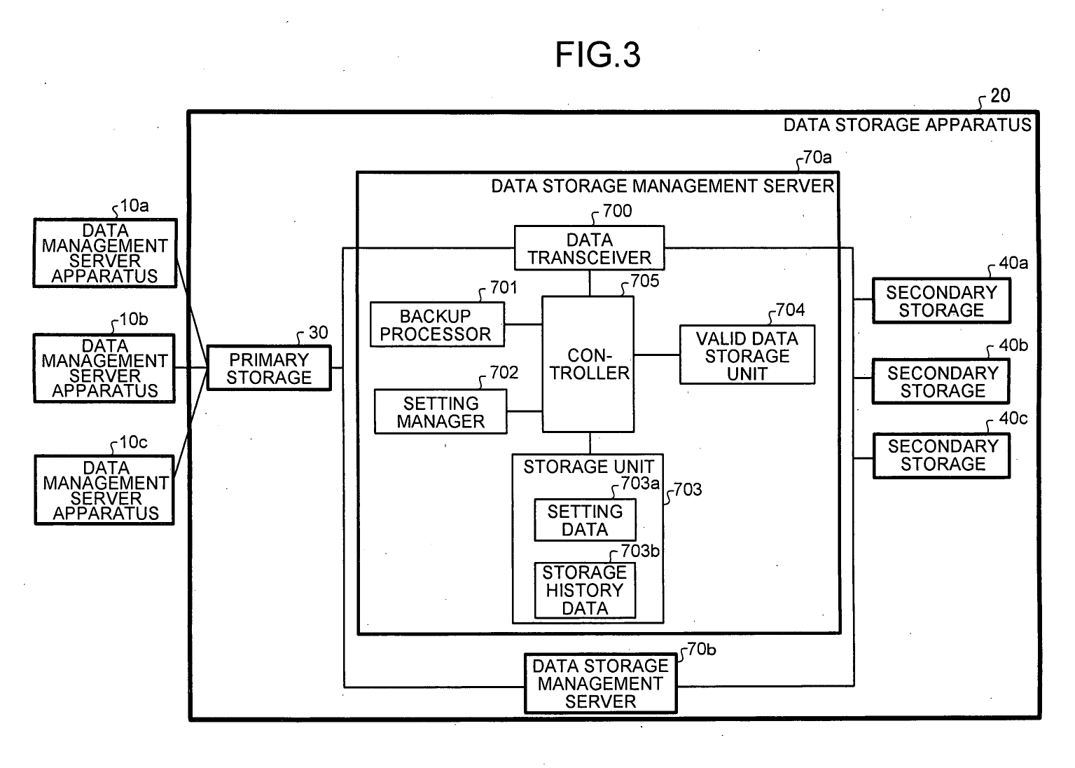

The functional configuration of a data storage apparatus according to a first embodiment will be explained next. FIG. 3 is a functional configuration diagram of the data storage apparatus 20 according to the first embodiment. The data storage apparatus 20 is connected via data management server apparatuses 10a to 10c, and a network. The data management server apparatuses 10a to 10c correspond to the data management server apparatus 10 described in FIG. 1.

The data storage apparatus 20 is configured by connecting the primary storage 30, data storage management servers 70a and 70b, and secondary storages 40a to 40c. The primary storage 30 corresponds to the hard disk apparatus described in FIG. 1, and the secondary storages 40a to 40c correspond to the magnetic tape storage apparatus that constitutes the secondary storage 40 described in FIG. 1.

The data storage management servers 70a and 70b migrate data stored in the primary storage 30 to the magnetic tapes of the secondary storages 40a to 40c, and, where necessary, recall data that is migrated to the magnetic tapes of the secondary storages 40a to 40c to the primary storage 30.

The data storage management servers 70a and 70b detect invalid data from among the data stored on the magnetic tapes of the secondary storages 40a to 40c, and store data excluding the invalid data on the new magnetic tape 50. In FIG. 3, two data storage management servers 70a and 70b are provided as a precaution against breakdown or the like.

Each of the data storage management servers 70a and 70b includes a data transceiver 700, a backup processor 701, a setting manager 702, a storage unit 703, a valid data storage unit 704, and a controller 705. The data storage management server 70b has the same configuration as the data storage management server 70a, and hence, the internal functional parts of the data storage management server 70b are not shown in FIG. 3.

The data transceiver 700 exchanges data between the primary storage 30 and the secondary storages 40a to 40c. The backup processor 701 migrates data stored in the primary storage 30 to the magnetic tapes of the secondary storages 40a to 40c by sequential access, as backup. The backup processor 701 also recalls data stored on the magnetic tapes of the secondary storages 40a to 40c to the primary storage 30.

When backing up data stored in the primary storage 30, the backup processor 701 writes storage history information, relating to data stored on the magnetic tapes of the secondary storages 40a to 40c, into the storage unit 703.

The setting manager 702 receives information relating to setting, such as the date of backup and garbage collection, and stores that information as setting data 703a in the storage unit 703. The setting can be performed by the data management server apparatuses 10a to 10c, and in such case, the primary storage 30 transmits the information relating to the setting, transmitted from the data management server apparatuses 10a to 10c, to the setting manager 702.

The storage unit 703 is a storage device such as a hard disk apparatus. The storage unit 703 stores the setting data 703a and the storage history data 703b. The setting data 703a relates to settings, such as the date/time of migration and garbage collection.

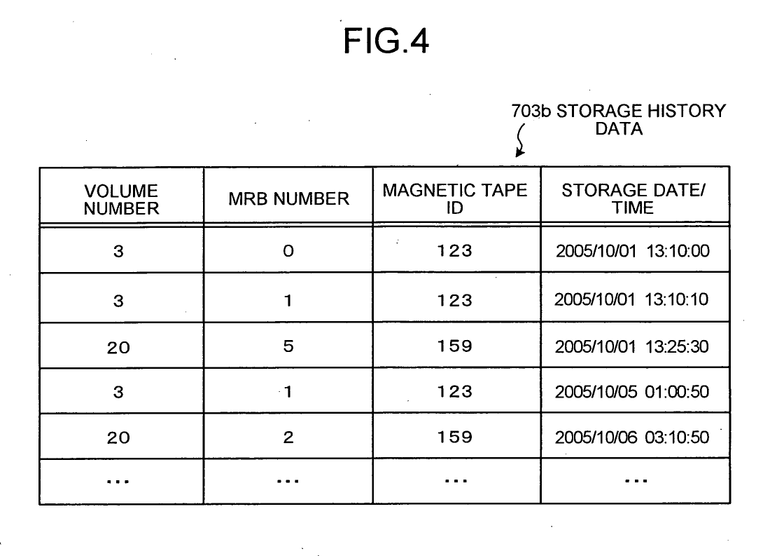

The storage history data 703b relates to the history of the migration of data stored in the primary storage 30 to the magnetic tapes of the secondary storages 40a to 40c. FIG. 4 is an example of the storage history data 703b.

The storage history data 703b includes a volume number, an MRB number, a magnetic tape ID, and a storage date/time. The volume number is allocated to each VLU of the primary storage 30, and represents the VLU where the migrated data is stored.

The MRB number is a number allocated to each MRB in the VLU, and represents the MRB in which the migrated data is stored. The magnetic tape ID is an identification number allocated to a magnetic tape to which data has been migrated. The storage date/time is the date and time at which the data is backed up onto the magnetic tape.

The storage history data 703b does not include any information indicating the position where the data is stored on the magnetic tape, that is, information relating to the block (MRB) of the magnetic tape where the data is stored. However, information relating to the storage history of the data is added to the storage history data 703b each time that the data is sequentially stored from the head block of the magnetic tape. Therefore, the block where the data is stored can be identified by the number of storage histories of the data.

Returning to FIG. 3, when the valid data storage unit 704 receives a request for garbage collection of a magnetic tape, the valid data storage unit 704 detects invalid data stored on the magnetic tape, deems data excluding the invalid data to be valid data, and controls the secondary storages 40a to 40c to store the valid data on a new magnetic tape.

More specifically, the valid data storage unit 704 consults the storage history data 703b, and retrieves data of the storage history having the same volume number, the MRB number, and the magnetic tape ID. Then, from among the data of the storage histories retrieved, the valid data storage unit 704 extracts all data other than those whose storage date/time is closest to the present time, detects data corresponding to the data having the extracted storage histories as invalid data, and stores data other than the invalid data on a new magnetic tape.

The controller 705 controls the entire data storage management server 70a, and manages exchange of data between its functional parts, and the like.

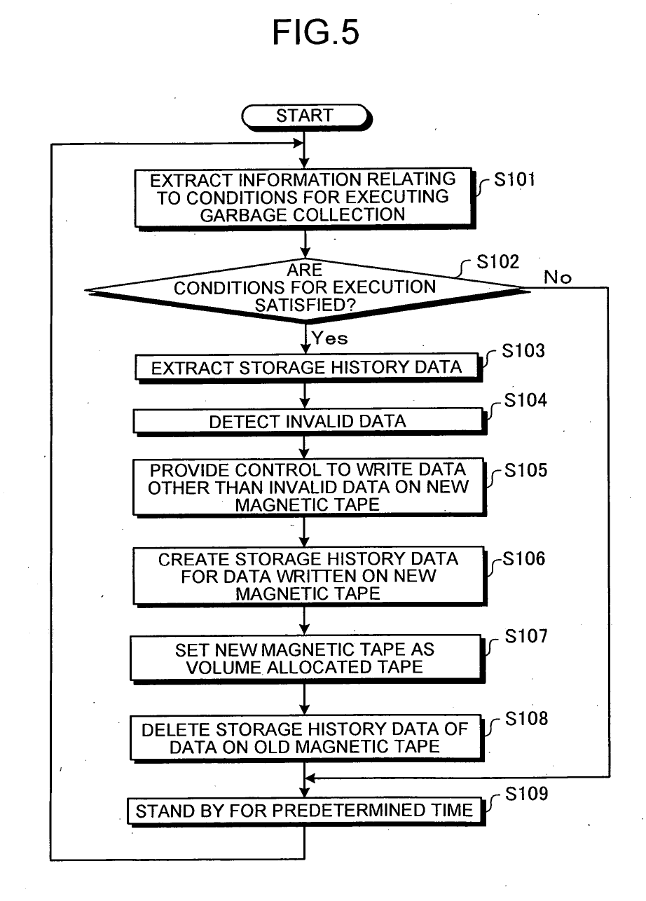

A process procedure of a garbage collection process according to the first embodiment will be explained next. FIG. 5 is a flowchart of the process procedure of a garbage collection process according to the first embodiment.

The valid data storage unit 704 of the data storage management servers 70a and 70b extracts information relating to conditions for executing garbage collection (step S101). More specifically, the valid data storage unit 704 reads the setting data 703a from the storage unit 703, and extracts setting information relating to the date/time at which the garbage collection is to be carried out, and the like.

The valid data storage unit 704 then determines whether the conditions for executing garbage collection are satisfied. Specifically, the valid data storage unit 704 determines whether the date/time for executing garbage collection has been reached (step S102). If the conditions are not satisfied (No at step S102), the valid data storage unit 704 stands by for a predetermined time (step S109), and returns to step S101.

If the conditions for executing garbage collection are satisfied (Yes at step S102), the valid data storage unit 704 reads the storage history data 703b from the storage unit 703 (step S103), and detects invalid data among the data stored in the magnetic tapes of the secondary storages 40a to 40c (step S104).

The valid data storage unit 704 then controls the secondary storages 40a to 40c to write data other than the invalid data, onto a new magnetic tape (step S105), and creates storage history data for the data that is written onto the new magnetic tape (step S106).

The valid data storage unit 704 then sets the new magnetic tape where the data is written as a volume allocated tape for the written data of the primary storage 30 (step S107), and deletes the storage history data related to the data on the old magnetic tape (step S108).

The valid data storage unit 704 thereafter stands by for a predetermined time (step S109), returns to step S101, extracts information relating to the conditions for executing garbage collection, and repeats the subsequent steps.

In the garbage collection process described above, garbage collection is executed based on a preset schedule, but the process is not restricted to this, and other conditions for executing garbage collection are acceptable.

For example, garbage collection may be executed when the data storage management servers 70a and 70b receive a request to execute garbage collection, from a manager of the data management server apparatuses 10a to 10c, or from a manager of the data storage apparatus 20, or the like.

If the data management server apparatuses 10a to 10c send a request to execute garbage collection, the primary storage 30 transmits the request to the data storage management servers 70a and 70b.

Alternatively, garbage collection may be executed when the amount of invalid data stored on the magnetic tape exceeds a stipulated amount. In such case, the valid data storage unit 704 of the data storage management servers 70a and 70b calculates the amount of invalid data among the data stored on the magnetic tape at regular intervals based on the storage history data 703b, and determines whether the amount of the invalid data is greater than the stipulated amount.

Alternatively, garbage collection may be executed when the load of processing performed by the backup processor 701 of the data storage management servers 70a and 70b either during writing data from the primary storage 30 to the secondary storages 40a to 40c, or during recalling data from the secondary storages 40a to 40c to the primary storage 30, is below a fixed level.

More specifically, the valid data storage unit 704 determines the load of the process of reading/writing data from the usage rate of the central processing unit (CPU) of the data storage management servers 70a and 70b, or from the amount of data transmitted and received by the CPU, or the like.

The determination as to whether to execute garbage collection may be based on a combination of a plurality of the conditions mentioned above.

In the garbage collection process described above, pre-updated data after data stored in the primary storage 30 is updated, is deemed invalid. However, the process is not restricted to this, and it is acceptable to deem as invalid data the data that is stored on the magnetic tapes of the secondary storages 40a to 40c prior to a date/time specified by the manager of the data management server apparatuses 10a to 10c, or from the manager of the data storage apparatus 20, or the like, and to store data other than the invalid data on a new magnetic tape.

As described above, in the first embodiment, the backup processor 701 stores data on the magnetic tapes of the secondary storages 40a to 40c, and stores information relating to the storage histories of the stored data, and the valid data storage unit 704 detects invalid data among the data stored on the magnetic tapes based on the information relating to the storage histories of the stored data, and stores data excluding the invalid data on a magnetic tape. Therefore, the data storage efficiency increases, because, only data other than the invalid data is stored.

In the first embodiment, the backup processor 701 writes data received from other apparatuses in the primary storage 30, and writes data stored in the primary storage 30 on the magnetic tapes of the secondary storages 40a to 40c. Therefore, in a layered storage apparatus in which the primary storage 30 that can access data rapidly by random access, and the magnetic tapes of the secondary storages 40a to 40c, which have large data storage capacity due to sequential access are combined, the data storage efficiency of the secondary storages 40a to 40c increases when data is migrated from the primary storage 30 to the secondary storages 40a to 40c.

In the first embodiment, when data in the primary storage 30 is updated and written onto the magnetic tapes of the secondary storages 40a to 40c, the valid data storage unit 704 detects, as invalid data, the data excluding the updated data for that magnetic tape of the secondary storages 40a to 40c, and stores data other than this invalid data on new magnetic tapes. Therefore, the data storage efficiency of the magnetic tape increases by deleting unwanted data.

The valid data storage unit 704 detects invalid data when the load of the process of writing data to the magnetic tapes of the secondary storages 40a to 40c, or reading data from the magnetic tapes, is a fixed amount or less. Therefore, it is possible to avoid any reduction in the processing efficiency when reading and writing data.

In a layered storage apparatus in which a hard disk that stores data by random access, and magnetic tapes that store data by sequential access are combined, data other than invalid data is stored on a new magnetic tape. Therefore, when migrating data from the hard disk that can access data rapidly to the magnetic tape that has a large storage capacity, it is possible to increase the data storage efficiency of the magnetic tape having a large storage capacity.

The valid data storage unit 704 detects data stored in the secondary storages 40a to 40c prior to a predetermined time as invalid data, and stores data other than the detected invalid data on a new magnetic tape. Therefore, the data storage efficiency of the magnetic tape increases by deleting the unwanted old data.

When the amount of invalid data exceeds a predetermined amount, the valid data storage unit 704 stores data other than the detected invalid data on a new magnetic tape. Therefore, if the amount of invalid data increases, the invalid data is automatically deleted, thereby increasing the data storage efficiency of the magnetic tape.

The valid data storage unit 704 detects invalid data based on a prestored schedule. Therefore, a planned increase in the data storage efficiency of the magnetic tape is possible.

When the valid data storage unit 704 receives a request from a user, to execute a process of storing data excluding invalid data on the magnetic tape, the valid data storage unit 704 detects the invalid data. Therefore, the data storage efficiency of the magnetic tape at a timing specified by the user, increases.

In the first embodiment, each time data stored in the primary storage 30 is stored on the magnetic tapes of the secondary storages 40a to 40c, history information such as the storage date/time is newly added to the storage history data 703b. However, when the data stored in the primary storage 30 is updated, it is acceptable to delete from the storage history data 703b, the information corresponding to the invalid data before the update, and store only the information that corresponds to the updated valid data in the storage history data 703b, thereby making garbage collection more efficient.

In a second embodiment, an example in which, when data stored in the primary storage 30 is updated and migrated to the magnetic tapes of the secondary storages 40a to 40c, history information of the data before the update, is deleted from the storage history data 703b is explained.

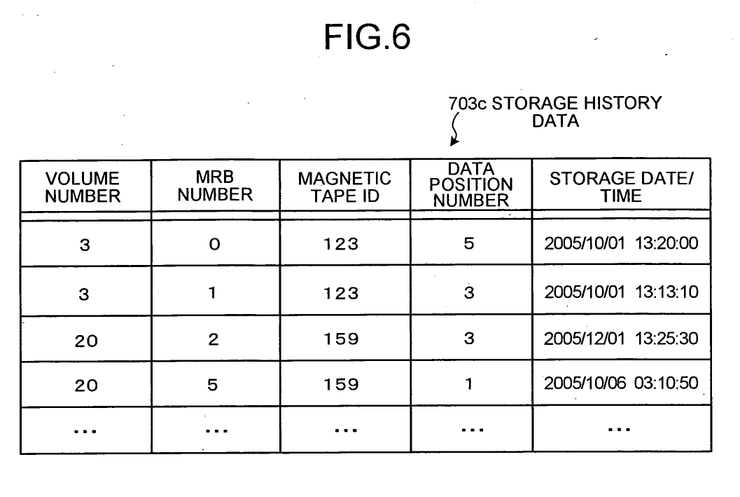

FIG. 6 is an example of storage history data 703c according to the second embodiment. The storage history data 703c includes a volume number, an MRB number, a magnetic tape ID, a data position number, and a storage date/time.

The volume number, the MRB number, the magnetic tape ID, and the storage date/time are the same as those in FIG. 4.

The data position number represents the position where data is stored on the magnetic tape identified by the magnetic tape ID. The magnetic tape is divided into storage regions including blocks (MRB), being the units for reading and writing data, and the data position number is allocated to each block sequentially from the head block.

In the second embodiment, each time the backup processor 701 of the data storage management servers 70a and 70b shown in FIG. 3 migrates data stored in the primary storage 30 to the magnetic tapes of the secondary storages 40a to 40c, information relating to the storage history of the data is added to the storage history data 703c.

When the data stored in the primary storage 30 is updated and migrated to the magnetic tapes of the secondary storages 40a to 40c, the backup processor 701 deletes storage histories of pre-update data (that is, data that has become invalid) from the storage history data 703c, and adds storage histories of the updated data.

As described above, in the second embodiment, when the data stored in the primary storage 30 is updated and migrated to the magnetic tapes of the secondary storages 40a to 40c, the backup processor 701 deletes the storage histories of pre-update data from the storage history data 703c, and stores the storage histories of the updated data as the storage histories in the storage history data 703c. Therefore, only the storage histories of valid data are registered in the storage history data 703c, and invalid data is deleted, thereby achieving efficient garbage collection processing.

The first and the second embodiments are examples where the data storage process is executed by a computer, but a program for executing the data storage process may be stored on a computer-readable recording medium, and the computer may read and execute the program stored on the recording medium.

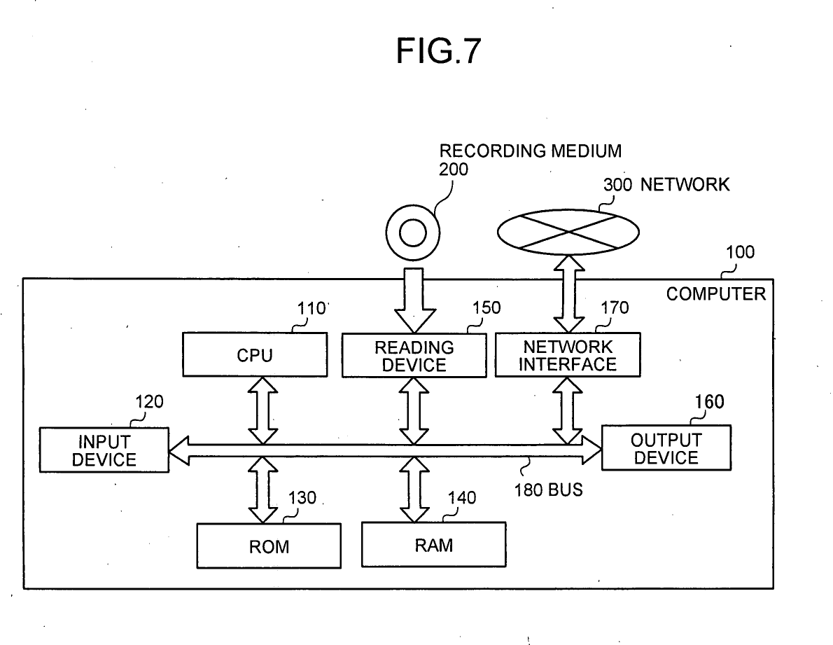

FIG. 7 is a block diagram of the hardware configuration of a computer 100 that executes data storage process. The computer 100 includes a CPU 110 that executes the program mentioned above, an input device 120 that inputs data, a read only memory (ROM) 130 that stores various types of data, a random access memory (RAM) 140 that stores calculation parameters and the like, a reading device 150 that reads a program for executing data storage process from a recording medium 200 on which the program is recorded, an output device 160 such as a display, a network interface 170 that exchanges data with another computer via a network 300, and these parts are connected by a bus 180.

The CPU 110 reads the program recorded on the recording medium 200 via the reading device 150, and executes the program to carry out data storage process. The recording medium 200 may be an optical disk, a flexible disk, a CD-ROM, a hard disk, or the like. The program may be introduced into the computer 100 via the network 300.

While exemplary embodiments of the present invention have been described above, variously modified embodiments other than the ones described can be made within the technical spirit of the appended claims.

For example, in the first and the second embodiments, the secondary storages 40a to 40c are magnetic tape storage apparatuses that store data on magnetic tapes. However, the present invention is not restricted thereto, and can be applied in other apparatuses such as an optical disk library, the only requirement being that the apparatus store data in a recording medium that stores data by sequential access.

In the first and the second embodiments, invalid data is deleted from the magnetic tape, and valid data is stored on a new magnetic tape. However, the present invention is not restricted thereto, and it is acceptable to store only the valid data on the same magnetic tape as that on which the invalid data exists, after deleting previously stored data, or the like.

In the first and the second embodiments, the primary storage 30 is a hard disk apparatus that stores data by random access, and the secondary storages 40a to 40c are magnetic tape storage apparatuses that store data by sequential access on a magnetic tape. However, the present invention is not restricted thereto, and all the apparatuses of the primary storage 30 and the secondary storages 40a to 40c may be ones that store data by random access, or ones that store data by sequential access.

In the first and the second embodiments, invalid data stored in the secondary storages 40a to 40c is detected, and data other than the invalid data is stored on new magnetic tapes of the secondary storages 40a to 40c. However, the present invention is not restricted thereto, and it is acceptable to detect valid data stored in the secondary storages 40a to 40c, and store the detected valid data on new magnetic tapes of the secondary storages 40a to 40c.

Of the respective processing explained in the embodiments, all or a part of the processing explained as being performed automatically may be performed manually, or all or a part of the processing explained as being performed manually may be performed automatically, by a known method.

The information including the process procedure, the control procedure, specific names, and various kinds of data and parameters shown in the data or in the drawing can be optionally changed, unless otherwise specified.

The respective constituents of the illustrated apparatus are functionally conceptual, and physically same configuration is not always necessary. In other words, the specific mode of dispersion and integration of the apparatus is not limited to those illustrated, and all or a part thereof may be functionally or physically dispersed or integrated in an optional unit, according to the various kinds of load and the status of use.

All or an optional part of the various processing functions performed by the apparatus can be realized by the CPU, or a program analyzed and executed by the CPU, or can be realized as hardware by wired logic.

According to the apparatus and the method for data storage, and the computer product of the present invention, the data storage efficiency of a recording medium that stores data by sequential access, increases.

Moreover, the data storage efficiency of a recording medium having a large storage capacity, increases.

Furthermore, the storage process is more efficient.

Moreover, the data storage efficiency of the recording medium that stores data by sequential access can be increased as planned.

Furthermore, the data storage efficiency of the recording medium that stores data by sequential access can be increased at a timing specified by a user.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A data storage apparatus comprising:
a first storing unit that stores data in a sequential-access recording medium based on a sequential access, and stores storage history information relating to a storage history of the data in a storage-history storing unit; and
a second storing unit that searches specific data from among data stored in the sequential-access recording medium based on the storage history information, and stores data excluding the specific data in the sequential-access recording medium.

2. The data storage apparatus according to claim 1, wherein the first storing unit stores data received from other apparatus in a random-access recording medium based on a random access, and stores the data stored in the random-access recording medium in the sequential-access recording medium.

3. The data storage apparatus according to claim 2, wherein the specific data is pre-update data when the data stored in the random-access recording medium is updated, and when the data updated is stored in the sequential-access recording medium.

4. The data storage apparatus according to claim 3, wherein when the data stored in the random-access recording medium is updated, and when the data updated is stored in the sequential-access recording medium, the first storing unit stores storage history information of the data updated, and deletes storage history information relating to the pre-update data.

5. The data storage apparatus according to claim 2, further comprising a data reading unit that reads the data stored by the second storing unit in the sequential-access recording medium, and stores the data read in the random-access recording medium, wherein
the second storing unit searches the specific data when a load of any one of a data storing process executed by the first storage unit and a data reading process executed by the data reading unit is equal to or less than a predetermined amount.

6. The data storage apparatus according to claim 2, wherein the random-access recording medium is a hard disk, and the sequential-access recording medium is a magnetic tape.

7. The data storage apparatus according to claim 1, wherein the specific data is the data stored by the first storing unit in the sequential-access recording medium before a predetermined time.

8. The data storage apparatus according to claim 1, wherein when an amount of the specific data exceeds a predetermined amount, the second storing unit stores the data excluding the specific data in the sequential-access recording medium.

9. The data storage apparatus according to claim 1, wherein the second storing unit searches the specific data based on a preset schedule.

10. The data storage apparatus according to claim 1, wherein the second storing unit searches the specific data when a user requests to execute a process of storing the data excluding the specific data in the sequential-access recording medium.

11. A data storage method comprising:
a data storing including
storing data in a sequential-access recording medium based on a sequential access; and
storing storage history information relating to a storage history of the data in a storage-history storing unit; and
a data re-storing including
searching specific data from among data stored in the sequential-access recording medium based on the storage history information; and
storing data excluding the specific data in the sequential-access recording medium.

12. The data storage method according to claim 11, wherein the data storing includes
storing data received from other apparatus in a random-access recording medium based on a random access; and
storing the data stored in the random-access recording medium in the sequential-access recording medium.

13. A computer-readable recording medium that stores therein a computer program that includes instructions, which when executed, make a computer execute:
a data storing including
storing data in a sequential-access recording medium based on a sequential access; and
storing storage history information relating to a storage history of the data in a storage-history storing unit; and
a data re-storing including
searching specific data from among data stored in the sequential-access recording medium based on the storage history information; and
storing data excluding the specific data in the sequential-access recording medium.

14. The computer-readable recording medium according to claim 13, wherein the data storing includes
storing data received from other apparatus in a random-access recording medium based on a random access; and
storing the data stored in the random-access recording medium in the sequential-access recording medium.

15. A data storage apparatus comprising:
a first recording medium;
a second recording medium;
a storing unit that stores at least storage history information relating to storage history of data stored in the first recording medium; and
a controller that provides a control to store only specific data from among the data stored in the first recording medium, in the second recording medium, based on the storage history information stored.

16. A data storage method of storing data, stored in a first recording medium, in a second recording medium, the data storage method comprising:
detecting invalid data from among the data stored in the first recording medium; and
storing data excluding the invalid data detected, in the second recording medium.

17. A data storage apparatus comprising:
a detecting unit that detects specific data from among data stored in a first recording medium; and
a controlling unit that provides a control to store any one of the data detected and data excluding the data detected, in a second recording medium.

18. The data storage apparatus according to claim 17, wherein
the detecting unit detects invalid data from among the data stored in the first recording medium; and
the controlling unit provides a control to store data excluding the invalid data detected, in the second recording medium.

19. The data storage apparatus according to claim 17, wherein
the detecting unit detects valid data from among the data stored in the first recording medium, and
the controlling unit provides a control to store the valid in the second recording medium.

20. A data input/output control apparatus comprising:
a first input/output unit;
a second input/output unit;
a detecting unit that detects specific data from among data input by the first input/output unit; and
a controlling unit that provides a control to output any one of the specific data or data excluding the specific data, to the second input/output unit, based on a result of detection by the detecting unit.
